(19) United States
(12) Patent Application Publication
(10) Pub. No.: US 2018/0245781 A1
(43) Pub. Date: Aug. 30, 2018

(54) FLAMELESS CANDLE MOUNT BRACKET

(71) Applicants: Todd J. Oxenford, Quakertown, PA (US); Aida L. Oxenford, Quakertown, PA (US)

(72) Inventors: Todd J. Oxenford, Quakertown, PA (US); Aida L. Oxenford, Quakertown, PA (US)

(21) Appl. No.: 15/445,191

(22) Filed: Feb. 28, 2017

(51) Int. Cl. F21V 21/08; F16M 13/02; F16B 47/00; F21S 6/00

(52) U.S. Cl. CPC F21V 21/0808; F21S 6/001; F16B 47/003; F16M 13/02

(57) ABSTRACT

A mount bracket is provided. The mount bracket includes a base plate and a slot plate. The base plate includes an upper surface and a lower surface opposite the upper surface. The upper and lower surfaces may be substantially flat. The slot plate includes a first sidewall and a second sidewall extending substantially vertical from the base plate and a top wall. The top wall bridges the first and second sidewalls together. The first and second sidewalls elevate the top wall above the base plate. The top wall includes an inner edge forming a bracket slot. The inner edge meets a front edge of the top wall forming an entrance into the bracket slot. A flameless candle fits in between the top wall of the slot plate and the base plate.

### BACKGROUND OF THE INVENTION

The present invention relates to flameless candles and, more particularly, to a flameless candle mount bracket.

Flameless candles are an electronic alternative to traditional wick candles. They are typically utilized as aesthetic lighting devices and come in a variety of shapes, colors and sizes. Because flameless candles are illuminated by a small light bulb, rather than an open flame, they pose less threat as fire hazards and do not melt or lose their form over time. Currently, during Christmas and other Holidays, a flameless candle may be used as a decoration. The flameless candle may be placed at a windowsill. The flameless candle may fall and cause fire hazard due to the hot light bulb.

As can be seen, there is a need for a mount bracket that secures a flameless candle to a surface.

### SUMMARY OF THE INVENTION

In one aspect of the present invention, an apparatus comprising: a mount bracket comprising: a base plate comprising an upper surface and a lower surface opposite the upper surface; a slot plate comprising a first sidewall and a second sidewall extending substantially vertical from the base plate and a top wall, wherein the first and second sidewall elevate the top wall above the base plate, wherein the top wall comprises an inner edge forming a bracket slot wherein the inner edge meets a front edge of the top wall forming an entrance into the bracket slot; and a connector operable to connect the mount bracket to a surface.

In another aspect of the present invention, an apparatus comprising: a mount bracket comprising: a base plate comprising an upper surface and a lower surface opposite the upper surface; a slot plate comprising a first sidewall and a second sidewall extending substantially vertical from the base plate and a top wall, wherein the first and second sidewall elevate the top wall above the base plate, wherein the top wall comprises an inner edge forming a bracket slot wherein the inner edge meets a front edge of the top wall forming an entrance into the bracket slot; a lamp comprising a shape of a candle, wherein the lamp comprises a circular base and an elongated candle portion, wherein the circular base is disposed in between the top wall of the slot plate and the base plate and the elongated candle portion extends through the bracket slot; and a connector operable to connect the mount bracket to a surface.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a detail perspective view of an embodiment of the present invention shown in use;

FIG. 3 is an upper perspective view of an embodiment of the present invention;

FIG. 4 is a lower perspective view of an embodiment of the present invention;

FIG. 5 is an exploded view of an embodiment of the present invention;

FIG. 6 is a section detail view of the present invention taken along line 6-6 in FIG. 2; and

FIG. 7 is a section detail view of an embodiment of the present invention shown in an alternate configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a bracket used to secure an electric window candle to a windowsill. The bracket secures the electric window candle to the sill to prevent it from falling over and causing a fire hazard from a hot light bulb. The candle slides into the slots on either side of the bracket and the bracket is fastened to the sill by using screws for permanent use or two-faced adhesive tape for temporary/seasonal use. The candle holder is not dependent on the window remaining closed and can be used year-round and/or in warmer climates when a user may want to open a window.

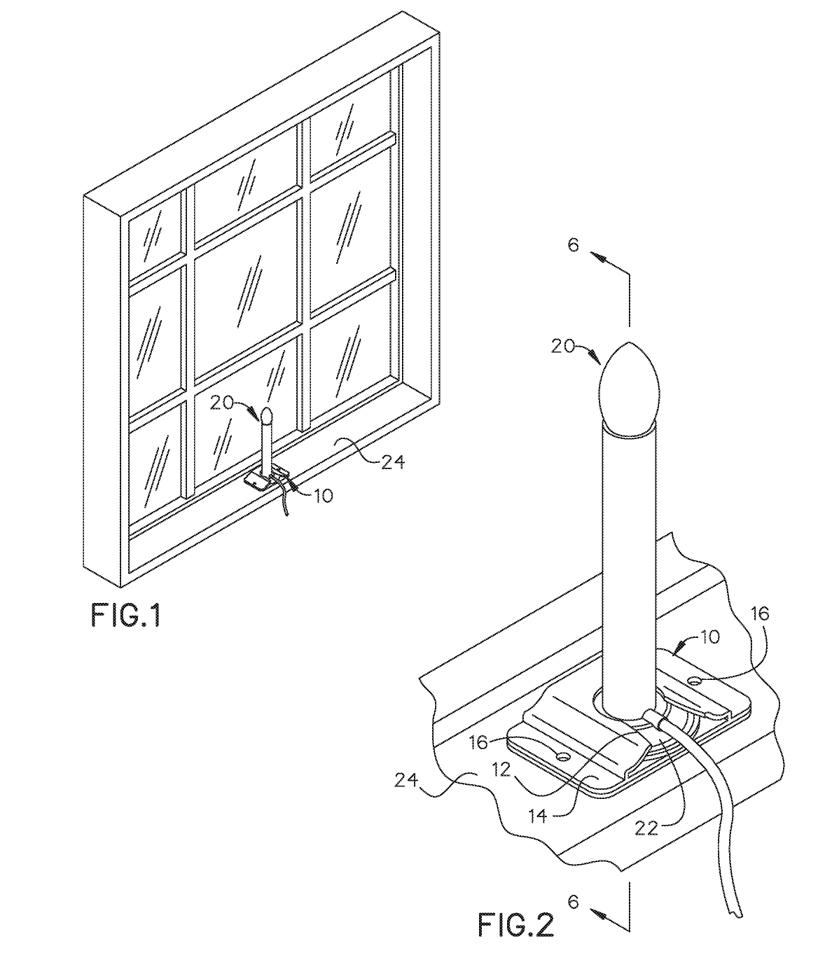

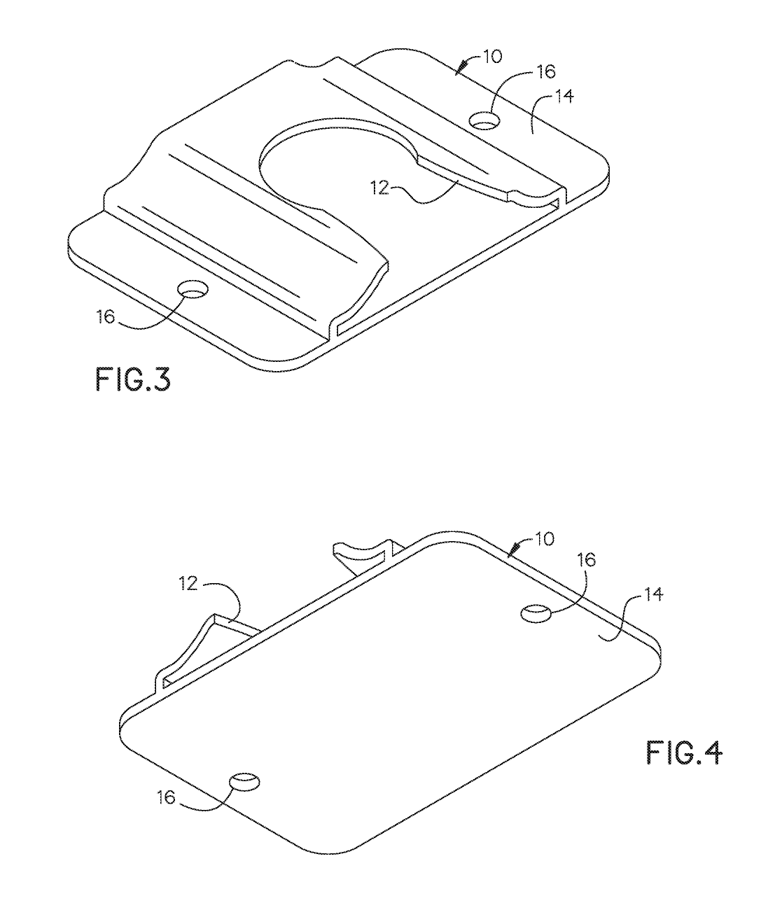

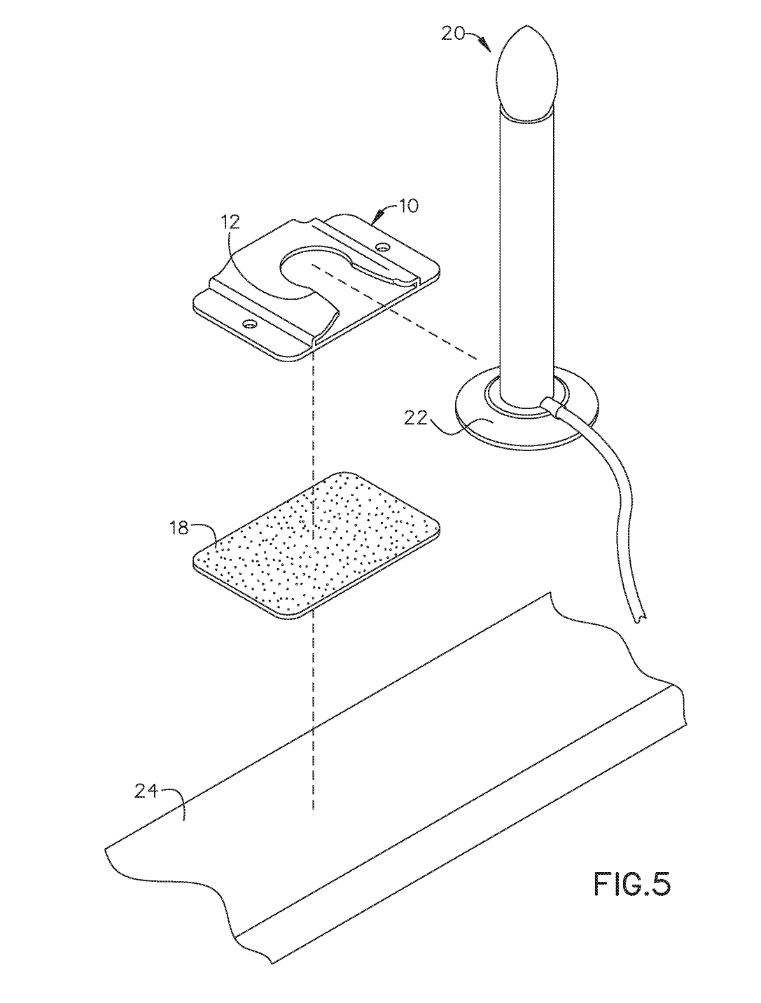

Referring to FIGS. 1 through 7, the present invention includes a mount bracket 10. The mount bracket 10 includes a base plate 14 and a slot plate 11. The base plate 14 includes an upper surface and a lower surface opposite the upper surface. The upper and lower surfaces may be substantially flat. The slot plate 11 includes a first sidewall 11a and a second sidewall 11a extending substantially vertical from the base plate 14 and a top wall 11b. The top wall 11b bridges the first and second sidewalls 11a together. The first and second sidewalls 11a elevate the top wall 11b above the base plate 14. The top wall 11b includes an inner edge forming a bracket slot 12. The inner edge meets a front edge of the top wall forming an entrance into the bracket slot 12.

The present invention further includes a connector. The connector secures the mount bracket 10 to a surface, such as a windowsill 24. In certain embodiments, the connector may include fasteners 26, such as screws or bolts. The base plate 14 may include a first aperture 16 and a second aperture 16 formed on opposing sides of the slot plate 11. The fasteners 26 may run through the apertures 16 and into the windowsill 24, thereby securing the mount bracket 10 to the windowsill 24. Alternatively, the present invention may include an adhesive layer 18, such as double sided tape. The adhesive layer 18 may be attached to the lower surface of the base plate 14. The adhesive layer 18 may secure the lower surface of the base plate 14 to the windowsill 24.

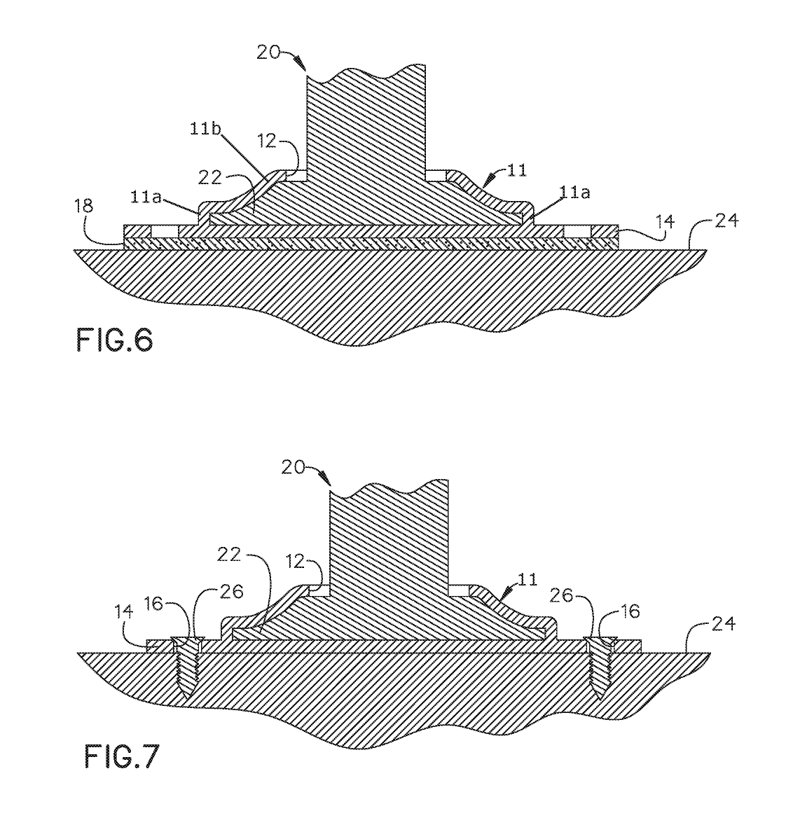

The mount bracket 10 of the present invention securely attaches a flameless candle 20 to a windowsill 24. A candle slot is formed in between the base plate 14 and the slot plate 11. The candle slot is shaped to fit a base 22 of a flameless candle 20 within. For example, the top wall 11b may curve upwards from the sidewalls 11a as illustrated in FIGS. 6 and 7. The bracket slot 12 may also conform to the flameless candle 20. For example, the entrance may be squared and the bracket slot 12 may be at least partially rounded to receive the elongated candle portion of the flameless candles 20.

The flameless candle 20 of the present invention may include circular base 22 that fits between the top wall 11b and the base plate 14 of the present invention. The flameless candle 20 further include an elongated candle portion extending through the bracket slot 12. The flameless candle 20 further includes a light bulb secured to a top end of the elongated candle portion. An electrical cord may be connected to an outlet and provide power to the light bulb.

It should be understood, of course, that the foregoing relates to exemplary embodiments of the invention and that modifications may be made without departing from the spirit and scope of the invention as set forth in the following claims.

What is claimed is:

1. An apparatus comprising:
a mount bracket comprising:
a base plate comprising an upper surface and a lower surface opposite the upper surface;
a slot plate comprising a first sidewall and a second sidewall extending substantially vertical from the base plate and a top wall, wherein the first and second sidewall elevate the top wall above the base plate, wherein the top wall comprises an inner edge forming a bracket slot wherein the inner edge meets a front edge of the top wall forming an entrance into the bracket slot; and
a connector operable to connect the mount bracket to a surface.

2. The apparatus of claim 1, wherein the connector comprises at least one bolt running through an aperture of the base plate.

3. The apparatus of claim 1, wherein the connector comprises an adhesive layer attached to the lower surface of the base plate.

4. The apparatus of claim 1, wherein the inner edge forming the bracket slot is at least partially rounded.

5. The apparatus of claim 1, further comprising a flameless candle comprising a circular base and an elongated candle portion, wherein the circular base is disposed in between the top wall of the slot plate and the base plate and the elongated candle portion extends through the bracket slot.

6. An apparatus comprising:
a mount bracket comprising:
a base plate comprising an upper surface and a lower surface opposite the upper surface;
a slot plate comprising a first sidewall and a second sidewall extending substantially vertical from the base plate and a top wall, wherein the first and second sidewall elevate the top wall above the base plate, wherein the top wall comprises an inner edge forming a bracket slot wherein the inner edge meets a front edge of the top wall forming an entrance into the bracket slot;
a flameless candle comprising a circular base and an elongated candle portion, wherein the circular base is disposed in between the top wall of the slot plate and the base plate and the elongated candle portion extends through the bracket slot; and
a connector operable to connect the mount bracket to a surface.

7. The apparatus of claim 6, wherein the connector comprises at least one bolt running through an aperture of the base plate.

8. The apparatus of claim 6, wherein the connector comprises a first bolt running through a first aperture of the base plate and a second bolt running through a second aperture of the base plate.

9. The apparatus of claim 6, wherein the connector comprises an adhesive layer attached to the lower surface of the base plate.

10. The apparatus of claim 6, wherein the inner edge forming the bracket slot is at least partially rounded.
